(19) United States
(12) Patent Application Publication
(10) Pub. No.: US 2025/0299183 A1
(43) Pub. Date: Sep. 25, 2025

(54) METHODS AND SYSTEMS FOR IMPROVED ANOMALY IDENTIFICATION THROUGH PRIVACY-ENHANCED TWO-STEP FEDERATED LEARNING

(71) Applicant: Rutgers, The State University of New Jersey, New Brunswick, NJ (US)

(72) Inventors: Jaideep S. Vaidya, East Brunswick, NJ (US); Hafiz Asif, Brooklyn, NY (US); Xinyue Wang, Harrison, NJ (US); Sitao Min, Harrison, NJ (US)

(73) Assignee: Rutgers, The State University of New Jersey, New Brunswick, NJ (US)

(21) Appl. No.: 18/638,356

(22) Filed: Apr. 17, 2024

Related U.S. Application Data
(60) Provisional application No. 63/496,844, filed on Apr. 18, 2023.

(51) Int. Cl. G06Q 20/38

(52) U.S. Cl. CPC G06Q 20/382; G06Q 20/389; G06Q 2220/00

(57) ABSTRACT

This disclosure provides methods and systems for anomaly identification through privacy-enhanced two-step federated learning. This disclosure also provides methods and systems for training a classifier for anomaly identification through privacy-enhanced two-step federated learning.

### CROSS-REFERENCE TO RELATED APPLICATIONS

This application claims priority under 35 U.S.C. § 119(e) to U.S. Provisional Patent Application No. 63/496,844, filed Apr. 18, 2023. The foregoing application is incorporated by reference herein in its entirety.

### STATEMENT REGARDING FEDERALLY SPONSORED RESEARCH

This invention was made with government support under Grant No. R35GM134927 awarded by the National Institute of Health. The government has certain rights in the invention.

### FIELD

This invention relates generally to methods and systems for anomaly identification through privacy-enhanced two-step federated learning and for training a classifier for anomaly identification through privacy-enhanced two-step federated learning BACKGROUND

Increasingly, data-based predictive analytics are the standard way to optimize industrial processes, customer management/classification, recommendation, and anomaly detection. However, federated/distributed data with sensitive information cannot be gathered at a central site, and the predictive models learned over local data lack generalizability, suffer from poor performance, and often have a significant bias that can lead to unfair/discriminatory results and decisions.

In many practical settings, federated learning or/and secure & privacy-preserving distributed methods are general ways to solve problems using data mining, data analytics, and Al-basée approaches when the actual data is distributed among multiple parties (i.e., organizations or institutions) e.g., patients information is distributed across hospitals, doctors' offices, and pharmacies, and financial transaction related information is distributed across the banks and financial institutions, and the institution that provides them with the communication protocol and infrastructure (e.g., SWIFT). However, the general methods are theoretical and suffer from issues with scalability or utility.

Therefore, there exists a need for improved methods to validate the information in a distributed setting.

### SUMMARY

This disclosure addresses the need mentioned above in a number of aspects. The methods and systems as disclosed herein provide an accurate, fast, efficient, scalable, and highly explainable way to validate the information in a distributed setting as well as provide a novel approach for federated learning; thus, helping meet the need for privacy, confidentiality, security, and fairness in federated/distributed data analytics.

In one aspect, this disclosure presents a method for anomaly identification through privacy-enhanced two-step federated learning. In some embodiments, the method comprises (a) determining a simple rule for each of a plurality of parties based on transactional data possessed by each party; (b) encoding the simple rule for each party using a local bloom filter that is specific for each party; (c) merging all local bloom filters of the plurality of parties by an aggregator through federated learning to generate a global bloom filter; (d) removing intrinsic anomalies from the transactional data by the aggregator using the global bloom filter to obtain an augmented dataset of the transactional data; (e) determining a classifier by the aggregator based on the augmented dataset; and (f) identifying complex anomalies using the classifier.

In another aspect, this disclosure presents a method for training a classifier for anomaly identification through privacy-enhanced two-step federated learning. In some embodiments, the method comprises: (i) determining a simple rule for each of a plurality of parties based on transactional data possessed by each party; (ii) encoding the simple rule for each party using a local bloom filter that is specific for each party; (iii) merging all local bloom filters of the plurality of parties by an aggregator through federated learning to generate a global bloom filter; (iv) removing intrinsic anomalies from the transactional data by the aggregator using the global bloom filter to obtain an augmented dataset of the transactional data; and (v) training a classifier by the aggregator based on the augmented dataset.

In some embodiments, the step of merging is performed by garbled circuits. In some embodiments, the step of determining the classifier is performed by training the classifier with XGBoost.

In some embodiments, the step of determining the classifier comprises augmenting the transactional data with account-level features.

In some embodiments, the parties comprise banks, and the aggregator comprises a financial institute, such as Worldwide Interbank Financial Telecommunications (SWIFT). In some embodiments, the transactional data comprises bank transactional data. In some embodiments, the transactional data comprises account information, such as bank account information.

In some embodiments, the simple rule comprises a rule-based classifier.

In some embodiments, the step of determining the simple rule comprises encrypting the transactional data.

In some embodiments, the intrinsic anomalies have an anomaly ratio greater than or equal to a threshold value. In some embodiments, the threshold value is 0.95. In some embodiments, the complex anomalies comprise statistical anomalies.

In some embodiments, the aggregator is implemented on one or more server devices.

In some embodiments, the classifier comprises a model based on linear regression, logistic regression, decision trees, support vector machines (SVM), naive Bayes, k-nearest neighbors or K-nearest neighbors (k-NN), K-means clustering, random forest, dimensionality reduction algorithms, gradient boosting algorithms, or neural networks. In some embodiments, the classifier comprises one or more machine learning models. In some embodiments, the classifier comprises a neural network, a convolutional neural network (CNN), a deep convolutional neural network (DCNN), a cascaded deep convolutional neural network, a simplified CNN, a shallow CNN, or a combination thereof.

In another aspect, this disclosure also provides a system for anomaly identification through privacy-enhanced two-step federated learning. In some embodiments, the system comprises an aggregator and one or more processors configured to: (a) determine a simple rule for each of a plurality of parties based on transactional data possessed by each party; (b) encode the simple rule for each party using a local bloom filter that is specific for each party; (c) merge all local bloom filters of the plurality of parties by the aggregator through federated learning to generate a global bloom filter; (d) remove intrinsic anomalies from the transactional data by the aggregator using the global bloom filter to obtain an augmented dataset of the transactional data; (e) determine a classifier by the aggregator based on the augmented dataset; and (f) identify complex anomalies using the classifier.

In yet another aspect, this disclosure presents a system for training a classifier for anomaly identification through privacy-enhanced two-step federated learning. In some embodiments, the system comprises an aggregator and one or more processors configured to: (i) determine a simple rule for each of a plurality of parties based on transactional data possessed by each party; (ii) encode the simple rule for each party using a local bloom filter that is specific for each party; (iii) merge all local bloom filters of the plurality of parties by an aggregator through federated learning to generate a global bloom filter; (iv) remove intrinsic anomalies from the transactional data by the aggregator using the global bloom filter to obtain an augmented dataset of the transactional data; and (v) train a classifier by the aggregator based on the augmented dataset.

The foregoing summary is not intended to define every aspect of the disclosure, and additional aspects are described in other sections, such as the following detailed description. The entire document is intended to be related as a unified disclosure, and it should be understood that all combinations of features described herein are contemplated, even if the combinations of features are not found together in the same sentence, or paragraph, or section of this document. Other features and advantages of the invention will become apparent from the following detailed description. It should be understood, however, that the detailed description and the specific examples, while indicating specific embodiments of the disclosure, are given by way of illustration only, because various changes and modifications within the spirit and scope of the disclosure will become apparent to those skilled in the art from this detailed description.

### BRIEF DESCRIPTION OF THE DRAWINGS

FIG. 1 shows an example setup of Payment Network Systems (PNS). The dotted line depicts the transaction to be made from Bank #1 and Bank #3; while the solid line depicts how the transaction goes through the PNS. PNS(T) denotes the data consisting of all the transactions at PNS.

FIG. 2 shows account metadata at banks connected via PNS.

FIG. 3 shows a 2-Step federated learning (FL) overview with a simpler setting (without rule mining) without incurring any additional privacy cost or any additional burden on any of the other parties.

FIG. 4 shows effectiveness w.r.t AUPRC of the disclosed federated solution. Four bank clients were considered. For parameters of the disclosed federated solution, κ denotes the false negative rate of the bloom filter, F represents the privacy budget in differential privacy.

FIG. 5 shows scalability of the disclosed federated solution.

FIG. 6 shows an example communication flow charts.

### DETAILED DESCRIPTION

This disclosure provides a novel privacy-preserving federated learning approach to identify anomalies, such as anomalous financial transactions in SWIFTNet. The approach utilizes a two-step anomaly detection methodology to solve the problem. In the first step, features are mined based on account-level data and labels, and then use a privacy-preserving encoding scheme to augment these features to the data held by an aggregator, such as SWIFT. In the second step, the aggregator now learns a highly accurate classifier from the augmented data. The experimental results show that the approach is highly accurate while being easy to implement and deploy. The approach has two major advantages: (i) there is no noteworthy drop in accuracy between the federated and the centralized setting, and (ii) the approach is extremely flexible since the aggregator can keep improving its model and features to build a better classifier without imposing any additional computational or privacy burden on participating parties, such as banks.

The disclosed methods and systems have various applications, including but not limited to:
(1) Secure and privacy-preserving input (e.g., bank/patient account information) validation in a federated/distributed setting—this is possible even when the parties holding the data may not know each other and don't trust each other.
(2) Secure feature mining (from sensitive data that is distributed), which can be augmented to other datasets to incorporate additional important correlations which are not covered by the dataset, thus improving the predictive power of the models learned over the dataset.
(3) A complete federated learning method to solve a range of machine learning problems
(4) Federated anomaly (e.g., financial crime) detection
(5) Checking users' account status in the setting where the users belong to different organizations/institutions (e.g., banks) and one organization's user information is only known to this organization.

### Anomaly Identification Through Privacy-Enhanced Two-Step Federated Learning

In one aspect, this disclosure presents a method for anomaly identification through privacy-enhanced two-step federated learning. In some embodiments, the method comprises (a) determining a simple rule for each of a plurality of parties based on transactional data possessed by each party; (b) encoding the simple rule for each party using a local bloom filter that is specific for each party; (c) merging all local bloom filters of the plurality of parties by an aggregator through federated learning to generate a global bloom filter; (d) removing intrinsic anomalies from the transactional data by the aggregator using the global bloom filter to obtain an augmented dataset of the transactional data; (e) determining a classifier by the aggregator based on the augmented dataset; and (f) identifying complex anomalies using the classifier.

In another aspect, this disclosure presents a method for training a classifier for anomaly identification through privacy-enhanced two-step federated learning. In some embodiments, the method comprises: (i) determining a simple rule for each of a plurality of parties based on transactional data possessed by each party; (ii) encoding the simple rule for each party using a local bloom filter that is specific for each party; (iii) merging all local bloom filters of the plurality of parties by an aggregator through federated learning to generate a global bloom filter; (iv) removing intrinsic anomalies from the transactional data by the aggregator using the global bloom filter to obtain an augmented dataset of the transactional data; and (v) training a classifier by the aggregator based on the augmented dataset.

In some embodiments, the step of merging is performed by garbled circuits. In some embodiments, the step of determining the classifier is performed by training the classifier with XGBoost.

In some embodiments, the step of determining the classifier comprises augmenting the transactional data with account-level features.

In some embodiments, the parties comprise banks, and the aggregator comprises a financial institute, such as SWIFT. In some embodiments, the transactional data comprises bank transactional data. In some embodiments, the transactional data comprises account information, such as bank account information.

In some embodiments, the simple rule comprises a rule-based classifier.

In some embodiments, the step of determining the simple rule comprises encrypting the transactional data.

In some embodiments, the intrinsic anomalies have an anomaly ratio greater than or equal to a threshold value. In some embodiments, the threshold value is 0.95. In some embodiments, the complex anomalies comprise statistical anomalies.

In some embodiments, the aggregator is implemented on one or more server devices.

In some embodiments, the classifier comprises a model based on linear regression, logistic regression, decision trees, support vector machines (SVM), naive Bayes, k-nearest neighbors or K-nearest neighbors (k-NN), K-means clustering, random forest, dimensionality reduction algorithms, gradient boosting algorithms, or neural networks. In some embodiments, the classifier comprises one or more machine learning models. In some embodiments, the classifier comprises a neural network, a convolutional neural network (CNN), a deep convolutional neural network (DCNN), a cascaded deep convolutional neural network, a simplified CNN, a shallow CNN, or a combination thereof.

In another aspect, this disclosure also provides a system for anomaly identification through privacy-enhanced two-step federated learning. In some embodiments, the system comprises an aggregator and one or more processors configured to: (a) determine a simple rule for each of a plurality of parties based on transactional data possessed by each party; (b) encode the simple rule for each party using a local bloom filter that is specific for each party; (c) merge all local bloom filters of the plurality of parties by the aggregator through federated learning to generate a global bloom filter; (d) remove intrinsic anomalies from the transactional data by the aggregator using the global bloom filter to obtain an augmented dataset of the transactional data; (e) determine a classifier by the aggregator based on the augmented dataset; and (f) identify complex anomalies using the classifier.

In yet another aspect, this disclosure presents a system for training a classifier for anomaly identification through privacy-enhanced two-step federated learning. In some embodiments, the system comprises an aggregator and one or more processors configured to: (i) determine a simple rule for each of a plurality of parties based on transactional data possessed by each party; (ii) encode the simple rule for each party using a local bloom filter that is specific for each party; (iii) merge all local bloom filters of the plurality of parties by an aggregator through federated learning to generate a global bloom filter; (iv) remove intrinsic anomalies from the transactional data by the aggregator using the global bloom filter to obtain an augmented dataset of the transactional data; and (v) train a classifier by the aggregator based on the augmented dataset. Example Implementation of Privacy-Enhanced Two-Step Federated Learning

Privacy Enhancing Technologies (PETs) have the potential to enable collaborative analytics without compromising privacy. This is extremely important for collaborative analytics can allow us to really extract value from the large amount of data that are collected in domains such as healthcare, finance, and national security, among others. To foster innovation and move PETs from the research labs to actual deployment, the U.S. and U.K. governments partnered together in 2021 to propose the PETs prize challenge asking for privacy-enhancing solutions for two of the biggest problems facing us today: financial crime prevention and pandemic response.

This disclosure presents a novel privacy-preserving federated learning approach to identify anomalous financial transactions in a payment network system (PNS). This approach utilizes a two-step anomaly detection methodology to solve the problem. In the first step, features are mined based on account-level data and labels, and then a privacy-preserving encoding scheme is used to augment these features to the data held by the PNS. In the second step, the PNS learns a highly accurate classifier from the augmented data. The disclosed approach has two major advantages: 1) there is no note-worthy drop in accuracy between the federated and the centralized setting, and 2) the approach is extremely flexible since the PNS can keep improving its model and features to build a better classifier without imposing any additional computational or privacy burden on the financial institutions.

Data is the lifeblood of the digital economy. The volume of data/information created, captured, copied, and consumed worldwide has grown consistently—from 2 Zettabytes in 2010 to 64.2 Zettabytes in 2020, with a forecast of over 180 Zettabytes by 2025. Data science, AI/ML, and analytics are being used to make sense of all of this data and utilize it. However, as more and more data are collected and analyzed, privacy is increasingly at risk. The risk to privacy has been identified and explicitly called out by the U.S. President in their recently released executive order on Safe, Secure, and Trustworthy Artificial Intelligence.

Privacy Enhancing Technologies (PETs) can be a potential solution to this conundrum, and the national strategy to advance privacy-preserving data sharing and analytics recognizes that PETs can protect privacy by removing personal information, by minimizing or reducing personal data, or by preventing undesirable processing of data, while maintaining the functionality of a system. However, despite the development of advanced PETs such as secure multiparty computation, homomorphic encryption, differential privacy, zero knowledge proofs, synthetic data, federated learning, and trusted execution environments, as well as significant development of research papers applying them to solve problems, their practical use is still quite limited.

In the financial crime track, the objective was to develop solutions that help tackle the challenge of international money laundering, which finances organized crime including human trafficking and terrorist financing, and undermines economic prosperity. The impact of this problem is immense, since money laundering costs up to US $2 trillion each year, according to UN estimates. Information sharing and collaborative analytics among financial organizations make it much more feasible to detect money laundering and financial fraud. However, it is difficult to realize such information sharing/analytics due to legal concerns with respect to privacy and institutional concerns due to autonomy and with respect to the confidential nature of the information. To solve this problem, in the financial crime prevention track, innovators were asked to develop end-to-end privacy-preserving federated learning solutions to detect potentially anomalous payments, leveraging a combination of input and output privacy techniques. Synthetic datasets created by SWIFT, the global provider of secure financial messaging services, were provided to the participating teams and used to develop general solutions. The solutions developed were judged on several different criteria, including privacy, accuracy, efficiency and scalability, adaptability, usability and explainability as well as innovativeness.

This disclosure presents the novel two-step approach for anomaly detection via privacy-enhanced two-step federated learning. The approach is both accurate and scalable. In the first step, features are mined based on account-level data and labels, and a privacy-preserving encoding scheme is then used to augment these features to the data held by PNS. In the second step, PNS now learns a highly accurate classifier from the augmented data. To classify a transaction, whether it is a simple rule-based anomaly was first checked. If it is, then it is labeled as an anomaly. However, if the transaction is not a simple anomaly, then the classifier is used to label it.

Overall, the solution has several advantages, including being extremely fast, scalable, and accurate (comparable to its centralized counterpart), as well as being highly flexible. In addition, by requiring only minimal changes to the existing architecture, it is eminently deployable in practice.

The financial track was aimed at developing privacy-preserving financial information sharing and collaborative analytics to detect anomalous payments without compromising the privacy of individuals' or organizational data. Using the insights from a synthetic global transactional dataset of a Payment Network Systems (PNS) (which was created by SWIFT), the approaches were implemented and then evaluated by by execution of the protocols on a standardized distributed environment. Additionally, the approaches were evaluated for their privacy and security guarantees.

One of the goals is to combine insights from transaction-level data, seen in the PNS, and the account level (meta) data known only to the respective bank. Thus, if the parties, i.e., banks and PNS collaborate, then collaborative machine learning can be used to build a classifier, i.e., decision model to identify the anomalous transaction before fully executing it via the network. The use of such collaborative analytics will boost system performance by lowering the risks of fraud, the average processing time, and the resource-wastage in processing the transactions across all parties, i.e., all banks and the PNS.

Since all of this information, contained in transactions and bank's data, is sensitive and confidential, it is imperative to protect privacy while learning the model. Ideally, no party should learn any additional information by contributing its data to build the classifier, and the model should not expose the private and sensitive information of individuals or banks. Thus, the use of PETs-based solutions, such as federated learning, homomorphic encryption, secure multiparty protocols, garbled circuits, and differential privacy, are befitting this setting. In particular, federated learning solutions were encouraged for they avoid sharing of raw data, and instead rely on learning and sharing parameters of a model to complete the learning task.

It is imperative to understand the basic setup of PNS and how data is distributed and what information about transactions and their processing is known to banks and PNS. The basic setup of PNS is needed to know how the data is distributed among the parties (i.e., banks and PNS), and hence, to construct an effective federated learning algorithm that is distributed in nature. How data is distributed and what information about transactions and their processing is known to banks and PNS is needed to determine exactly what information is known to which party when a transaction is processed, and hence, to quantify information leakage appropriately.

### 1.1 PNS Setup, Transactional and Account Meta Data

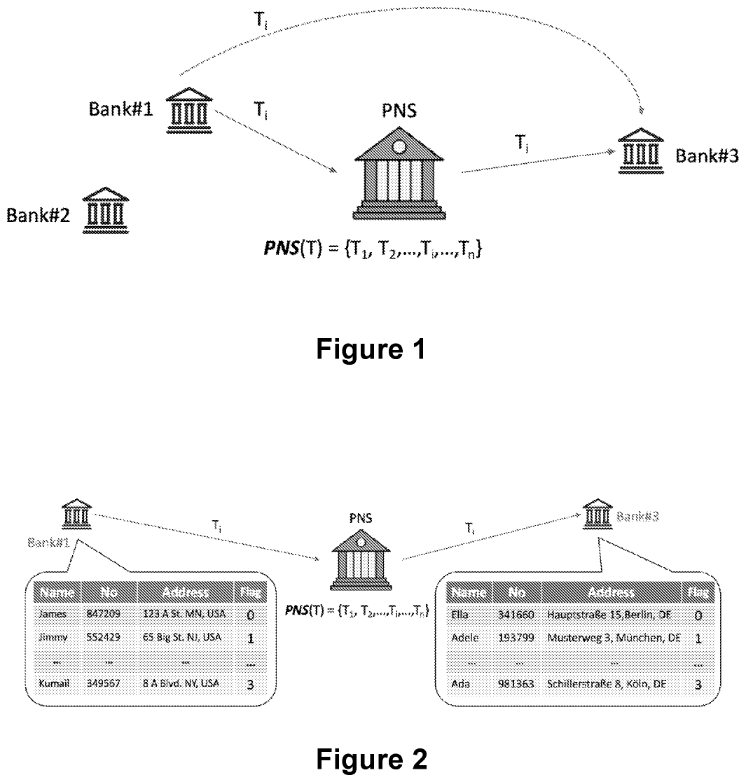

A payment network system such as SWIFT consists of advanced Internet protocol-based messaging platform (and network), which enables the participating institutions (e.g., banks) to send standardized messages, such as pertaining to processing/execution of a transaction, to each other (see FIG. 1 for a basic setup of a PNS). Namely, each message/transaction first goes to PNS and is then sent to the next recipient. It was assumed that the PNS, executing a transaction, sees all the information in the transaction and stores it, which gives the transactional data, PNS(T), at PNS site. A party that has the view of PNS refers to a party that controls the network and sees all the messages passing through it.

As shown in FIG. 1, there are N banks participating in PNS, each with its customers who can send and/or receive money via wire transfers, i.e., transactions executed via PNS (see example transaction below).

T [symbol] := Transaction

| Ordering Account | Beneficiary Account |
|---|---|
| Number: 187234871236 | Number: 635234892460 |
| Name: John Doe | Name: Jane Doe |
| Address: 25 1^{st} St, NYC, | Address: Hauqtstraße 123, |
| NY 11233, USA | 10827 Berlin, DE |
| Bank: Dominion Bank | Bank: Schneider Bank |
| Amount: 5000; Currency: USD; | |
| Time: 11:01:01 | |

Each bank has the account information (i.e., metadata), for example, bank account number, account name, street address, country, and an account-level feature, called Flag: which captures the status or behavior of the account, e.g., whether the account is operating normally (Flag=00), under monitoring (Flag=05), or suspended (Flag=06). See FIG. 2 and compare it to the table above for differences in transaction level data and account (i.e., banks) level data. Also, it is possible, and often it is the case, that account level information in the transaction is incorrect.

While making a transaction (i.e., transferring funds), all the account information (i.e., bank, account number, name, and address) of the ordering account (i.e., the one sending the funds) and beneficiary account except for Flag's values (as well as the recipient bank and other transaction details, e.g., amount and currency) is shared with PNS (i.e., the PNS system).

### Sufficiency of Single Flag Feature

As long as the account level characterization is given by a set of finite features, one account-level feature, e.g., Flag, is sufficient to capture the necessary correlations. The account level characterization features are defined over a finite space (this assumption is supported by the data provided by PNS). Since finite space defined by multiple features (each of which is finite) can be mapped to a single finite feature via one-to-one mapping, the account-level features were simplify by considering only a single feature Flag.

### 1.2 Data Distribution & Parties' Knowledge

For each transaction that is executed via PNS, PNS is provided with the ordering and beneficiary accounts' information which can be incorrect amount and currency details, and the receiving bank for the transaction.

To simplify the exposition, the notion of full transaction was conceptualized from an ordering account in bank i, let's call it i-Bank, to the beneficiary account in j-Bank (where i and j are two unique integers between 1 and N that denote individual, non-identical, banks). Each full transaction consists of all the information known (i.e., sent) to PNS (as part of the transaction) as well as the information of ordering and beneficiary accounts, which are only known to the banks i-Bank and j-Bank.

### Federated Data Distribution

Let T be the set of full transactions under consideration (e.g., pertaining to the training data). T is distributed both vertically and horizontally such that:

Vertical partitions: T is vertically partitioned between PNS and the banks: PNS(T) consists of transaction-level features (or attributes) known to PNS and Bank(T) consists of account-level meta data (e.g., correct account information and the corresponding Flag values).

Horizontal partitions: Bank(T) is horizontally partitioned among banks such that only the ordering account's bank knows the attributes of the ordering account and the beneficiary account's bank knows the attributes beneficiary account. i-Bank(T) was use to denote the account level data for the transactions where i-Bank's account was ordering or beneficiary.

Thus, for any full transaction, τ∈T, from i-Bank's ordering account to j-Bank's beneficiary account, PNS(τ) gives the transaction-level data available at PNS site, while ord(τ) gives account-level data of the ordering account from i-Bank(T), and ben(τ) gives account-level data of the beneficiary account from j-Bank(T). Furthermore, oFlag(τ) and bFlag(τ) was used respectively to denote the ordering and beneficiary accounts' flag value; and use Label(τ) to denote the label for the transaction, Label(τ)=1 for anomalous and Label(τ)=0 for normal.

### Knowledge of the Parties in PNS

PNS knows all the transaction level features as they pass via PNS. Thus, they are contained in PNS(T). Additionally, as per the understanding, PNS also gets to know the status reason code for transactions: the codes reveal to PNS if the transaction was executed successfully or was unsuccessfully terminated or denied due to invalid account information or some non-normal status of the account.

Thus, it was that following is the minimal information leakage for PNS: it knows if a transaction is successfully executed; and if a transaction is denied due to invalid account information or “non-normal” account status; it knows that the failure was due to either, but it cannot distinguish between the two reasons. In addition, since end-to-end transactions are visible to PNS, it also knows the bank-membership of the ordering and receiving account.

The information leakage for banks processing a transaction (whether the sender or the receiver) is such that they know PNS(T); furthermore, it was assumed that a bank processing the transaction knows the reason code, and if the bank contains the ordering (or beneficiary) account, it knows know the valid account level data.

### 1.3 Differential Privacy

Differential privacy (DP) aims to preserve individual's privacy while publishing statistical information about a database. DP provides formal guarantees that the distribution of query results changes only slightly with the addition or removal of a single record in the database. Formally, a mechanism (randomized algorithm) M is ε-differentially private if for all possible sets of the outputs, S⊆Range(M), and all neighboring database (that differ by a single record) D and D′, it results in:

$$P r ( M ( D ) ∈ S ) \leq {e}^{ε} \times Pr ( M ( {D}^{′} ) ∈ S ) ,$$

where ε≥0, and it quantifies the level of privacy. The higher its value, the weaker the privacy guarantee.

Attribute level differential privacy was also employed, where the only difference is how the neighboring databases are considered. In attribute-DP, neighbors are considered only in terms of set of sensitive attributes as opposed to all attributes (sensitive or otherwise).

Two important properties of DP that were relied on are sequential and parallel composition. According to sequential composition, when a single data point (or record) is used in n independent ε-DP computations, the overall DP guarantee reduces to (nε)-DP. On the other hand, in parallel composition, when mutually exclusive partitions of the database are used by independent ε-DP computations, the overall privacy guarantee remains the same, i.e., ε-DP.

Laplace mechanism was used to achieve DP. For count queries (which just count the number of records in a database satisfying a given property), Laplace mechanism adds independently sampled noise form Laplace distribution (of mean 0 and scale 1/ε²) to the true answer—the perturbed answer is guaranteed to be ε-DP.

### 1.4 Bloom Filters (BF)

In the approach, PNS(T) was augmented with a secure and privacy-preserving encoding of account-level features (which are known to banks). And for this encoding scheme, bloom filters (BFs) were used. BF is a probabilistic data structure that allow for the storage and look up of elements. The data stored in a BF is not directly retrievable. Once data is ‘inserted,’ data can be checked to see if it likely has been seen or if it definitely has not. BF is a space-efficient option with an acceptable false positive rate, and has been widely used in many fields; for instance, they are employed for privacy-preserving biometric issue. Many variants of BF exist. The case where the BF is a bit vector of length α was considered. All the bits are initialized to 0. To insert an element, w independent hash functions are used to randomly map the element into w positions in the bit vector, which are set to 1. To query if an element is a member, BF maps the element into its bit vectors with the w hash functions. If all the w bits are 1s, then the element is considered to be in the BF and otherwise not.

### 2 Technical Approach

Given the analytical objective, the unique nature of data and how it is distributed across parties, i.e., PNS and banks (discussed in Section 2.4), and the requirements for an easily deployable solution, a domain- and problem-specific solution was selected because this enables an improved trade-off between the practical usability and protection of the data.

The approach was first described in the centralized setting (where all the data is gathered at one site). Then the novel two-step federated learning anomaly detection method was proposed, which extends the centralized setting to the collaborative setting. Note that the term ‘federated learning’ was used in its more general sense of collaborative learning. In the first step of the approach, features were mine based on account-level data (from banks) and labels (from PNS); a novel privacy-preserving encoding scheme was then used to encode these features. In the second step, PNS uses the secure encoding to create augmented data (PNS(T)+) to build a classifier to identify anomalies.

The federated approach (as outlined below):
is extremely fast and accurate (comparable to its centralized counterpart), and it requires minimal changes to the existing architecture—it actually builds upon it;
can detect one of the most challenging anomalies, which occur due to mis-specification of information (e.g., incorrect name, account number, or address) without compromising privacy;
can preserve all sensitive information, not only at the account level but also at the model level (privacy objectives are outlined in Section 3.1);
is also highly flexible; this is because once the data is augmented, any classifier can be built on the augmented data without an active involvement of other parties, allowing drop-in replacement with newer technology;
is very scalable, allowing new banks to be added in, and is also easily explainable.

### 2.1 Privacy Objectives

The aim is to learn a global anomaly detection model using PNS(T) and banks' data, i.e., 1-BankData, 2-BankData, . . . , N-BankData without sharing raw data, i.e., via federated learning, and without compromising sensitive information. Here, i-BankData denotes all the account-level data that i-Bank has on its customers.

The sensitive information to be protected is all personally identifiable information, namely, account number, name, address, Flags (when it is non-zero, i.e., the account is flagged), transaction identifiers, and timestamps. Thus, the proposed approach will assure that this information is not leaked or compromised.

A semi-honest threat model was considered, i.e., the parties faithfully follow the protocol, but they may try to gain more information through the messages they send or/and receive. It was assumed that the parties do not collude with each other; in particular, the PNS site does not collude with any bank. Thus, the privacy guarantees of the method was established under the simulation model; namely, they do not gain more information than what is explicitly defined as their input, output, and anything that can be inferred using them (for details see Section 4). Furthermore, differential privacy was used to protect the sensitive information, e.g., various time frequencies (how many transactions are initiated by a sender per unit time) in the classification model, which could be released or shared with parties other than PNS.

### 2.2 Approach for the Centralized Setting

The following discusses how the approach works if all the data was available at one site. Algorithm 1 gives an overview the approach in this centralized setting. Below details for each of the steps in Algorithm 1 except for the last one were provided, which simply runs a learning algorithm over the provided differentially private augmented data to obtain a classifier. For the PETs challenge, the performance of many classifiers was evaluated, and it was found that XGBoost outperformed other models for the anomaly detection task and therefore utilized it.

Algorithm 1 Centralized Approach

Input: T, set of full transactions; γ ϵ (0, 1), threshold; differential privacy
parameters, ε₁, ε₂
Output: Classifier C⁺
1: m-Features←Mine Flag-based features (with anomaly-ratio > γ) from
T (ε₁-DP)
2: PNS(T′)+ ← Augment Features to PNS(T′) via bloom filter based
encoding
3: dp-PNS+train ← Make sensitive features in PNS(T′)+ ε₂-differentially
private
4: Learn classifier, C⁺ (e.g., using XGBoost) over dp-PNS+train

To classify a transaction, first compute its Flag-based features' values, augment them to PNS's transaction-based features, and then use C+ to obtain its classification.

### 2.2.1 Account-Level (Flag-Based) Feature Mining

Recall that the aim is to leverage the account-level (meta) data with transaction data to improve the overall detection. To do this, feature mining that focuses on capturing information about anomalous (or normal) behavior of transactions was performed as it pertains to account-level data.

Anomalous transactions have two types: intrinsic anomalies and complex anomalies. Account-level rules (driven from account-level data) were used to define intrinsic anomalies—for brevity, referred to as rules. These rules are solely based on the account-level data, and they were used to assess whether a transaction is invalid, i.e., it is an intrinsic anomaly. For instance, the rule that ‘money cannot be wired to an account that does not exist’ is an example of (account-level) rule. Clearly as per the rule, a transaction for a beneficiary account that does not exist is an intrinsic anomaly. Thus, a transaction is an intrinsic anomaly if it is anomalous with high probability (i.e., ≈1) when it fails to satisfy one of the account-level rules. Note that without the account-level features (derived from account-level data) intrinsic anomalies cannot necessarily be distinguished from normal records.

A complex anomaly, on the other hand, is an anomaly that is not an intrinsic anomaly. Namely, complex anomalies can satisfy all the account level rules; when they do not, this information (i.e., violation of some rules) alone is not sufficient to identify them-though it can be necessary to do so. Therefore, building a high-accuracy classifier to identify complex anomalies requires training data consisting of the features derived from both the PNS's data (i.e., PNS(7)) and the banks' data (i.e., 1-BankData, . . . , N-BankData). How the account-level was mined is described, i.e., Flag based, rules from the data, which have sufficient support. These rules will be used to create account-level features (which will later be augmented to PNS's data). A pair of Flag values, (f, f′), were used, where f is for the ordering account, and f is for beneficiary account. Naturally, each transaction r is linked to such a pair, and the pair to the account level rule. Since there are |Flag|² many pairs (|Flag|=number of possible flag values), only the pairs with sufficient support were used. This support is called anomaly-ratio and denote it as r(f, f′), defined by Eq.(1):

$$r ( f , f ) = \frac{\vert τ ∈ S ( f , {f}^{′} ) \vert Label ( τ ) = 1 \vert}{\vert S ( f , {f}^{′} ) \vert}$$

where S(f, f′) is the set of all transactions in T where ordering and beneficiary Flag values are f and f′, i.e., S(f, f′)={τ∈T| oFlag(τ)=f and bFlag(τ)=f}.

To account for the rules that depend only on the beneficiary account (or only on the ordering account), (*, f) (or (f, *)) were used, where * indicates the independence with respect to the ordering (or beneficiary) account respectively.

To mine the rules, all the relevant Flag-pairs were identified. To do this, the rules were divided into three categories based on the anomaly-ratios. The first category corresponds to the ratios that are close to zero (or below a threshold, e.g., 0.1), and is ignored completely. The second category—called simple rules—corresponds to the ratios that are close to one (e.g., greater than 0.9), resulting in rules to identify intrinsic anomalies. The third category—called complex rules—corresponds to the rest not covered by the first or the second categories. The specific thresholds can be specified by the domain experts or empirical analysis. Let m-Features denote the set of all the pair corresponding to simple and complex rules given by the mining process.

How to achieve privacy: While mining Flag-based features, differential privacy (DP) were guaranteed in computing r(f, f′) (discussed DP in Section 2.5). (ε₁/2)-DP Laplace mechanism was used to independently perturb both the numerator (|S(f, f′)|) and the denominator (the number of anomalies in S(f, f′)) for each r(f, f′). Thus, guaranteeing overall ε₁-DP in this process (which follows from serial and parallel composition of DP).

### 2.2.2 Bank and Account-Level Feature Encoding Via Bloom Filters

There are two types of account level features to be encoded: 1) account information (e.g., account number, name, address, etc.) and 2) mined features/rules given by the pairs in m-Features. The following is needed: 1) so that whether the specified account-level details in a transaction are correct otherwise the transaction cannot go through can be validated and will be considered anomaly (note that this will correspond to simple anomaly and is clearly independent of the Flag values). Solving this problem while protecting privacy is a significant obstacle. Next, these encoding, i.e., derived features, are augmented to the PNS's transactions data, T.

Since for each transaction τ in T and every pair (f, f′) in m-Features, either τ∈S(f, f′) or τ∉S(f, f′), the mined features was encoded as membership relations using bloom filters (described in Section 2.6), shortly called filter (described in detail below). Bloom filters was used for their superior performance for rule-validation and the security and privacy properties they provide; additionally, they were used to develop a privacy-preserving encoding and membership evaluation protocol in the federated setting (presented shortly).

A simple example was first used to describe the encoding scheme and then give general methods for different scenarios. Consider (*, f′): it is encoded by adding to a filter all the accounts with Flag value f′. Now, for a given transaction and a filter (encoding a rule), whether the beneficiary account is in the filter was checked: if it is then the filter's output is 1 (i.e., it satisfies the rule for being likely anomalous) and otherwise 0.

After the rules have been encoded, the filter's output was used, corresponding to each feature/rule, as the feature's value and augment it to PNS's data, PNS(T)− these new features are rule-based features (as they are computed by evaluating the rules). Let PNS(T)+ denote the PNS data augmented with the account-level features.

Below, three approaches were provided to support a variety of Flag-based rule encoding via bloom filters. First, multiple account-related data elements, e.g., number, name, street, country, in one filter were encoded and validated. Let ‘acc_info’ contain all the necessary account-level information for an account, i.e., for the setting: ‘acc_info’=acc #∥name∥street∥country, where∥denotes concatenation. Now, instead of the account number (as done earlier) for each account, add its ‘acc_info’ to the filter. This allows validation of the complete account information via one filter.

Second, consider simple rules like (f₁, *), . . . , (fₐ, *) (or (*, f₁), . . . , (*, fₐ)). All of them via one filter can be encoded by adding ‘acc_info’ for all the accounts whose Flag value is in {f₁, . . . , fₐ}. To evaluate the rule, whether the given ‘acc_info’ is in the filter was checked; and if it is, then the filter's output is 1, meaning that the account has a feature value that likely leads to its transaction being anomalous, and the output is 0 otherwise. All the rules in the provided data are of this form; thus one bloom filter is sufficient to capture all the rules.

Third, consider more general rules, given by a pair of Flag values, i.e., (f, f′). To encode such a rule, create a filter-pair (BF, BF′): BF is for the ordering account and BF′ is for beneficiary account. Then, to the filter BF, the account information, ‘acc_info’, for each account with Flag=f; was added to the filter BF′. ‘acc_info’ for all the accounts with Flag=f. To evaluate the rule, (f, f′) was added, and whether ‘acc_info’ for the ordering account is in the filter BF with its output being b (∈{0, 1}) was checked, and whether beneficiary account is in the filter BF′ with its output being b′ was checked. Now, if 2b′+b=3 then the transaction is likely anomalous.

From storage and computation complexity, all account-level feature-based rules will lead to smaller sized filters as the flagged accounts, i.e., having the account's status that is anomaly prone, only constitute a tiny proportion of the total accounts.

### 2.2.3 Extracting Transaction-Level Features and Assuring DP for Sensitive Features

Once PNS's data is augmented, feature extraction and evaluation at the PNS site without involving any other party (i.e., the banks) was performed. Here, one can use any befitting learning/classification algorithm and the evaluation metrics. This flexibility is indeed one of the powerful features of the approach as it allows for a continuous improvement by using or incorporating more advanced or newly developed learning and data mining methods.

How to achieve privacy: Firstly, non-sensitive data that are strong predictors was used. For account-level (meta) data-based feature, the augmented features (which, in federated setting, will be derived using BF-based privacy-preserving encoding) were directly relied on. To protect privacy of the sensitive features (namely, features containing sensitive information or derived using some sensitive information), generalization (e.g., hours instead of actual time) was used as well as attribute differential privacy (discussed in Section 2.5). For example, a sensitive feature that is computed using counts related to sensitive information can be made differentially private by perturbing the counts using Laplace mechanism; whereas for averages or mean (or other functions) that have higher ‘sensitivity’ (i.e., the magnitude of change to be hidden, known as global sensitivity in DP literature), smooth sensitivity based DP methods can be used for the perturbation.

### 2.3 Privacy-Enhanced Anomaly Detection Via Two-Step Federated Learning

How the approach can be extended from the centralized setting to the federated setting is described as follows. A distinguishing feature of the federated approach is to leverage the knowledge PNS has about the transactions to design a protocol that, on the one hand, improves the accuracy of classification, and on the other, reduces the leakage of sensitive information (Section 4) for more details). Thus, PNS was chosen as the central server/aggregator site as well. Even if a different site was selected for the central server, the information-leakage to PNS will remain the same. To extend the approach to privacy-enhanced federated learning, the following three main tasks were performed:
1. Securely learn Flag-based (i.e., account-level) rules from banks' data and PNS's data.
2. Make the bloom filter-based encoding (to be shared with PNS) secure as well as privacy-preserving so that PNS cannot carry out attacks (e.g., brute force or attacks similar to using rainbow tables) to obtain account information encoded in the filters.
3. Securely extract the values for Flag-based features for all the transactions in the training data and augment the training data with these features' values.

Algorithm 2 Privacy-Enhanced Two-Step Federated Learning

Input: PNS(T) at PNS; i-Bank(T) and i-BankData (all the account-level
data) at i-Bank for i = 1, . . . , N ; key size, λ; differential privacy
(DP) parameters, ε₁, ε₂
Output: Classifier C⁺ at PNS
FIRST STEP: Secure rule mining and encoding

| | |
|---|---|
| 1: | All banks collaboratively securely generate PRF's, F , key k* (of |
| | length λ) |
| 2: | All banks and PNS securely and collaboratively mine |

Flag-based rules i-Bank(T) using Flag values from and Label in PNS's
data with ε₁-DP guarantee

| | |
|---|---|
| 3: | All banks collaboratively run secure sum protocol to estimate |

the number of accounts (across all banks) to be added to each bloom filter
(BF) and compute the BF's size

| | |
|---|---|
| 4: | for i = 1, . . . , N do |
| 5: | For each rule, i-Bank initializes the local filter and adds to |

it the secure encoding, i.e., E[‘acc_info’] = Fₖ* (h(‘acc_info’)), of all
the accounts from i-BankData that conform to the rule (i.e., have specified
Flag values)

| | |
|---|---|
| 6: | Send all local BFs to PNS |
| 7: | end for |

SECOND STEP: Secure aggregation, augmentation, and learning

| | |
|---|---|
| 8: | For each rule, PNS aggregates all the received local filters into a |
| | global filter |
| 9: | PNS gets the secure encodings of the ordering and beneficiary |

accounts for each transaction by sending their hashes to the sender bank.

| | |
|---|---|
| 10: | PNS uses the global filters and the received secure encodings to |

compute values of the Flag-based features and augments them to its
training data.

| | |
|---|---|
| 11: | PNS extracts features (with ε₂-DP guarantee) from the |
| | augmented data and learns C⁺ |

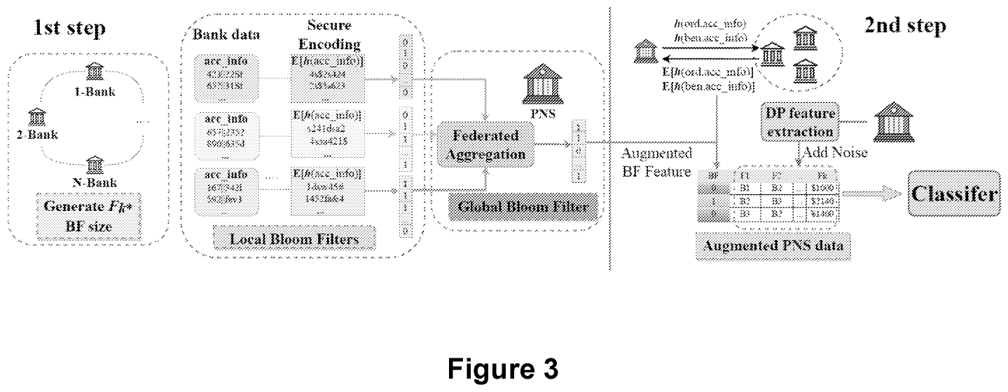

Tasks #1 and #2 are completed in the first step of the learning process, it requires banks to mine account-level features/rules and build a privacy-preserving global bloom filter for PNS via federated learning. Once PNS is provided with the bloom filters, it needs to carry out task #3, which it does by asking the sender bank of each transaction to provide secure encoding of the ordering and beneficiary account information for the transactions note that PNS cannot perform this on its own, a privacy feature of the approach; after receiving the secure encodings, PNS populates the Flag-based (i.e., account-level) features, augments them to its data, and learns the classifier (by following other steps discussed in the centralized setting, detailed in the previous section)—this constitutes the second step. Thus, the approach is named two-step federated learning and is outlined in Algorithm 2. FIG. 3 gives an overview of the proposed solution in a simpler way.

Even in the federated setting, once PNS has obtained augmented data, it is free to choose any learning method and feature extraction method to build the classifier, C+, for anomaly detection. Thus, the approach is extremely flexible and agile, where PNS can keep improving its model and features to build a better classifier without imposing on banks to carry additional computational burden or risk privacy of their customers by sharing more information.

### 2.3.1 Secure and Privacy-Preserving Feature/Rule Mining

The banks use a secure protocol to count and compare the number of anomalies to identify rules. For instance, for a rule (f, f′), the banks securely compute if the anomaly-ratio=|a(f f′)|/|S(f, f′)|>p/q (where p≤q); here a(f, f′) is the set of anomalies in S(f, f′) (the set of all transactions with ordering and beneficiary accounts' Flag as f and f′). This, for example, can be done by computing, E[q·|a(f, f′)|] and E[p×S(f, f′)|](where E[⋅] means the value inside is not accessible, e.g., it may be encrypted or consists of distributed random shares) and compare them without ever revealing the the actual values. Note that for |S(f, f′)|, q>0, anomaly-ratio>p/q if and only if q·|a(f, f′)|p·|S(f, f′)|>0.

To achieve differential privacy, the counts |a(f, f′)| and |S(f, f′)| were perturbed in a way that no one party is able to remove noise from the counts. Let |a(f, f′)|=Σᵢ₌₁^{N}|aᵢ(f, f′)| and |S(f, f′)|=Σᵢ₌₁^{N}|Sᵢ(f, f′)|,
where |aᵢ(f, f′)| and |Sᵢ(f, f′)| are the corresponding counts at the i-Bank. Now, two banks were chosen, i-Bank and j-Bank, at random to perturb their counts via ε₁-DP Laplace mechanism. Now, only i-Bank or j-Bank can remove the added noise, but each one can remove the noise that it added and not the noise added by the other bank. Hence, the counts are always guaranteed to be differentially private. To ensure that PNS doesn't learn anything about the results of rule mining, the results of comparison are only shared with the banks and never with PNS.

As noted earlier for the provided dataset in the PETs challenge, rule mining is completely unnecessary since: simple rules are fixed and all complex anomalies correspond to non-flagged accounts (as discussed in the implementation part of Section 3.2.1). Then, the next task in the first step is for banks to carry out secure encoding of the Flag-based features, which is explained next.

### 2.3.2 Privacy-Preserving Rule Encoding and Aggregation

Here, the second important task in the 1st step of the approach is described. This consists of creating secure encoding for the Flag-based features (i.e., account-level data) using pseudorandom function (PRF, e.g., AES block cipher), F, as well as a cryptographic hash function, h (e.g., sha3), using the secure encodings to construct local bloom filters at each bank's site, and then performing aggregation of secure local bloom filters into global bloom filters at PNS's site.

To accomplish the aforementioned, the banks need to collaboratively pick a random key, k*∈{0, 1}^{λ}, for the PRF while keeping it secret from PNS (or any other party). A PRF, F, takes two inputs, (randomly picked) key, k*, and message, m; and its output is depicted as Fₖ*(m). PRF ensures that an adversary who has some messages and their corresponding PRF outputs still cannot predict the output for a new message that it has not yet seen. Additionally, all the banks and PNS need to know the size of bloom filter (corresponding to each Flag-based feature) that depends on the error rate (κ) one is willing to tolerate and the total number of elements to be added to the filter, e.g., total number of valid non-flagged accounts across all banks. Thus, they have to securely compute the estimates (e.g., in the upper-bound sense) of the total number of accounts, across all banks, to be added to each bloom filter without revealing the number of accounts for any one bank as well. Below, details on how to do this are described.

Secure encoding. Firstly, all the banks need to securely generate the key, k*, of length λ: Each i-Bank randomly picks a string kᵢ of length λ and shares it with all the other banks. With this, each bank can get k*=k₁⊕k₂e⊕ . . . ⊕k_{N}, where ⊕ is for bit-wise XOR operation.

Secondly, the banks use the secure sum protocol described below to compute the total number of accounts to be added to a bloom filter as follows. Let's say nᵢ(f) is the upper-bound estimate of the accounts in i-Bank that have Flag=f, and p be a sufficiently big prime number (e.g., greater than any 32-bit long positive number). Now, 1-Bank picks a random number r∈{0, 1, . . . , p−1} and sets sec_sum_{N}=r. Next, for i=1, . . . , N, i-Bank computes sec_sumᵢ=sec_sumᵢ₋₁+nᵢ(f) mod p and sends sᵢ to (i+1)-Bank (N-Bank sends sec sum_{N} to 1-Bank). 1-Bank computes sum=sec_sum_{N}−r mod p and shares it with all the banks. Banks use sum and pre-agreed upon error rate, κ, to compute the size of the filter. It is easily possible to modify this protocol to make it resistant to collusion between parties as well.

Then, each bank builds its local secure bloom filters and adds to them the secure encoding of the relevant accounts (as per the rules following the method discussed in in Section 3.2.2 for the centralized setting). The name of the bloom filters bears no association with the value of Flag, which can simply be achieved by using PRF as a block cipher under CBC (cipher block chaining) mode. This ensures that the correspondence between rules and the filters remains secret. Secure bloom filter assures that when PNS (or any party or an adversary) receives only the secure bloom filter, it cannot carry out an attack (e.g., by brute force or something similar to rainbow tables) to figure out which accounts are in the bloom filter, and which are not. To build a secure bloom filter, instead of adding the account information, ‘acc_info’, to the bloom filter, E[‘acc_info’]=Fₖ*(h(‘acc_info’)) was added to the bloom filter. Note that given access to such a filter—but not to Fₖ*—one cannot check if an account is in the filter even if the adversary knows the account information—this follows from the security properties of PRF.

Secure aggregation. Since each (bloom) filter consists of indexed bits, each local filter is a binary string of length α: Let's say, for i=1, . . . , N, xᵢ is the binary string of i-Bank corresponding to its secure local bloom filter for a rule. Then, the global filter for the same rule is: y=x₁Vx₂ V . . . Vx_{N} (where yⱼ=x₁ⱼVx₂ⱼV . . . Vx_{Nj}). Note that this does not affect the correctness of the bloom filter because the the filter is initialized with all bits as zero and then any bit (in the bit array of the filter) corresponding to an index where a value is hashed is set to one.

Thus, all the local filters corresponding to one feature were aggregated/combined into a global bloom filter by OR-ing the bits at the same indices. To do this, secure local bloom filters are sent to PNS who carries out the aggregation. By using pseudorandom function before adding the account information to the bloom filters, PNS was stopped from carrying out attacks on the filters. The approach ensures that PNS—despite having access to the filters-cannot evaluate any of the rules on a new account without a bank's permission, which stop attacks from the PNS side.

### 2.3.3 Feature Augmentation and Learning the Classifier

Once all the filters have been aggregated, PNS collects all the transactions, PNS(T)ᵢ, originating from each bank, i-Bank for i=1, . . . , N; then for each transaction in τ′∈PNS(T)ᵢ, PNS sends the hash of the account info., i.e, h(‘acc_info’), for the ordering and beneficiary accounts of τ′ to i-Bank; in response i-Bank sends secure encoding, i.e., Fₖ*(h(‘acc_info’)), for each of these accounts.

After PNS receives the secure encodings for all the (ordering and beneficiary) accounts, it evaluates rules via the secure global filters, and uses the results to augment its training data. Now, PNS carries out the same steps as detailed in the centralized setting to learn the C⁺.

### 3 Privacy Analysis

The semi-honest adversarial model was considered, that is, each party (bank or PNS) will follow the given protocol (i.e., the distributed/federated algorithm) but may try to gain more information from the intermediate data/messages it receives. For the basic solution, none of the parties collude. This restriction can however be relaxed by using threshold homomorphic encryption. Privacy is ensured both in terms of the federated protocol as well as the model computed to find anomalies. A formal proof using the simulation paradigm is given below to show that the protocol does not reveal any additional information beyond that explicitly stated. Since differential privacy is used to protect account-level feature mining as well as the sensitive features created by PNS, the overall model is protected.

### Ideal Paradigm

There is a fully trusted third party, T-party, whom PNS sends its data, i.e., PNS(T), and each i-Banks sends i-BankData (all the account-level data that it has). T-party carries out the computation as described in the centralized setting and returns:
to PNS: I₁: (n, n′) for each mined rule (RF(f), RF(f′)) (with anomaly-ratio>γ for the rule (f, f′)), where where RF denotes random function, and n (or n′) gives the number of accounts with Flag=f (or f′), and when f (or f′) is * the corresponding count is zero. I₂: Values of the augmented features, named as RF(f)∥RF(f′). I₃: Additionally, for each RF(f)∥RF(f′), as leakage, PNS also receives additional feature values corresponding to RF(f′)∥RF(f). In the implementation for the challenge, as part of I₂, PNS only gets the total number of non-flagged accounts and the corresponding feature values (1 if ordering account info. is incorrect or the account is flagged, 2 if the same is true for the beneficiary account, 3 if it's true for both, and 0 otherwise). Thus, for the implementation for the challenge, I₂ and I₃ will be the same, and there will be no additional leakage.
to i-Bank: I₁: (n, n′) for each mined rule (f, f′) (with anomaly-ratio>γ). I₂: list of the ordering and beneficiary accounts for the transactions initiated by the i-Bank (note that this information is always known to the bank that initiates a transaction).

### Real Paradigm

The real paradigm corresponds to the execution of two-step federated learning method, which reveals the following information to the parties:
to PNS: R₁: (n, n′) for each mined rule (f, f′) (with anomaly-ratio>γ) with feature names as Fₖ*(f)∥Fₖ*(f), where Fₖ* is pseudorandom function, Fₖ*, used as a block cipher in CBC mode. R₂: bloom filters for each Fₖ*(f)∥Fₖ*(f′) (which have been populated using Fₖ* and h for the relevant accounts by all the banks). R₃: Secure encodings of the ordering and beneficiary accounts for each transactions initiated by the i-Bank for i=1, . . . , N.
to i-Bank: R₁: kⱼ (a randomly picked string of length λ) (from j-Bank). R₂: (n, n′) for each mined rule (f, f′). R₃: Partial secure sum, i.e., see sumᵢ₋₁ for each mined rule (f, f′). R₄: cryptographic hashes of the ordering and beneficiary accounts for the transactions initiated by the i-Bank.

It was shown that the view of a non-colluding probabilistic polynomial time (PPT) semi-honest adversary controlling any party in the real paradigm can be simulated by the view of the same party in the ideal paradigm; i.e., the two views, one in the ideal paradigm and the other in the real paradigm, are computationally indistinguishable to any PPT adversary. Note that here, by view, it was meant all the information that a party has including its input, results, and intermediate messages received as well as all information it can construct (in polynomial time) from this.

### Indistinguishablity of PNS's View.

Let us first look at an adversary controlling PNS in the ideal paradigm. I₁ and R₁ are the same. Because PRF's output is (computationally) indistinguishable from that of RF's, RF (f)∥RF(f′) is indistinguishable from Fₖ*(f)∥Fₖ*(f′) for the adversary. It was shown how the adversary can simulate the view of PNS from real paradigm for R₂ and R₃. For each feature, RF(f)∥RF(f), the adversary initializes a pair of bloom filters (BF, BF) of sizes given by (n, n) and κ, which are known to PNS and the adversary. Then using the values of the feature, RF(f)∥RF(f), given by I₂, it adds the account info. to the relevant BFs. For example, if for a transaction, RF(f)∥RF(f′)=1 then it adds the ordering account's info., i.e., ‘acc_info’, as RF (h(‘acc_info’)) to B\hat{ }F, if RF(f)∥RF(f)=2 then it adds the beneficiary account's info. To [symbol] , and if RF(f)∥RF (f)=3 then it adds the ordering account's info. to [symbol] ′ and the beneficiary account's info. to BF respectively. Furthermore, it keeps counts of total number of accounts added to each bloom filter, let's say z and z′ are respectively the counts for [symbol] and [symbol] ′; then for M=n−z and j=1, . . . , M, the adversary adds RF (j) to [symbol] ′, and for j=M+1, . . . , M+n′−z′, RF (j) to [symbol] . The adversary does the same for I₃ but swaps the info. of ordering account with that of the beneficiary account. The same procedure is repeated for each of the augmented feature. R₃ can be simulated by considering all the accounts info. added to the bloom filters (i.e., RF (h(‘acc_info’))'s) from the above. The simulatability claim of the view follows from the indistinguishability of PRF from RF.

Indistinguishability of i-Bank's View.

R₁ can be simulated by generating a randomly picked string of length λ. I₁ and R₂ are the same. As for R₃, i.e., sec_sumᵢ₋₁, since r is uniformly distributed over {0, . . . , p−1}, so is sec_sumᵢ₋₁. Thus, the i-Bank in real paradigm gets the sum, e.g., n or n′, when i=1, and uniformly distributed sec_sumᵢ₋₁ when i≠1. When in ideal paradigm the adversary is controlling 1-Bank, it knows the corresponding sum from I₁, otherwise it can generate an (distributionally) indistinguishable sec_sumᵢ₋₁ by picking a random number. Lastly, R₄ can be generate by hashing the account given in I₂. Thus, even at the bank level, the adversary can simulate the view. This completes the proof.

### 3.1 Inevitable Information Leakage

The information leakage that is inevitable was described and analyzed; this is due to the fact that using all banks' data together with PNS's data, i.e., Flag values, results in a better classifier, C⁺. Over time a party who is given C⁺ to classify transactions can learn a probabilistic association of Flag values for accounts.

Note that C⁺ is better because it can identify more anomalies than C, a classifier learned only over data without Flag related features (e.g., PNS's data). In particular, C⁺, with high probability, can identify all the anomalies that C can identify. But there are additional anomalies that C⁺ can identify (which are missed by C); this is due to the fact that Flag—which is directly or indirectly used by C⁺—is useful in identifying these additional anomalies. This information can be used to infer probabilistically correct associate of Flag values for an account.

attack I. Noting the aforementioned, let's say a party, P (e.g., PNS), is given C⁺ to classify transactions. Overtime, P gathers transaction and compile a dataset P (Tₙ) of n transactions. P remove from P (Tₙ) the features related to Flag, and use this dataset to learn a classifier C. Next, P uses C⁺ and C to label all transactions. Any transaction that C⁺ labels as anomalous but C labels as normal, is anomalous due to Flag value of the account being used (directly or indirectly) in C⁺. Furthermore, for each such anomaly, P inspects the paths of the decision tree(s) of C⁺ that are taken by these anomalies and how they compare to other anomalies and normal records. Using this information and the data from P (Tₙ), P estimates the distribution, giving the probabilistic association of Flag values, for the accounts present in the transactions in P (Tₙ).

Ways to reduce this leakage: One, use a secure and distributed version of C⁺ so that no one party can access C⁺, and the classification result is only revealed to the relevant banks. This, however, will be extremely slow and will increase the transaction processing time undesirably. Two, randomize values for Flag. For instance, instead of Flag, use E[Flag], a randomized form of Flag, obtained by encrypting all the values of Flag with semantically secure encryption. This will hide the precise values of the Flag but the distribution will still be inevitably revealed. Thus, the two approaches give a way to trade-off security and utility.

Let us now look at the information leakage for PNS and banks and possible attacks to extract more information.

PNS's knowledge: PNS knows PNS(Tₙ). Among other information, PNS can learn: (1) what's the valid/invalid account details for an account; (2) which transactions were processed successfully, and which ones failed; (3) which banks an account belongs to; (4) and does an account's Flag value is such that it makes the account's transactions anomalous. Without any prior knowledge, PNS does not know what accounts a bank has if it has not appeared in a transaction from PNS(Tₙ). Below the attacks that can help PNS gain some of the non-obvious information mentioned above are outlined.

attack II. The account details for a successful transaction are correct. If a transaction is failed (i.e., anomalous) due to invalid info., with high probability, it will be made again. Thus, by comparing new transactions with the older ones (e.g., using edit distance over the ordering and beneficiary account details and Euclidean distance over the amount, time etc.), PNS can infer, with high probability, what are the valid and invalid details for an account.

attack III. Let us say the classifier C⁺ (learned over PNS(Tₙ)+, i.e., the data consisting of transaction level and Flag-based features) is given to PNS to identify anomalies. Now, using its data, i.e., PNS(T), and the strategy outlined in attack I, PNS can obtain probabilistic association of Flag values for accounts.

i-Bank's knowledge: Each i-Bank knows i-BankData (account level data for its accounts), iBank(Tₙ) (all transactions for which i-Banks was sender or receiver bank). Note that for the accounts in transactions in iBank(Tₙ), i-Bank can also carry out attack II. Furthermore, the bank can also carryout attack I. This is possible even when i-Bank doesn't have C⁺. i-Bank can build an approximation of C⁺ using its account-level data and use it instead of C⁺ to carry out attack I.

### 4 Experimental Evaluation and Results

### 4.1 Experimental Setup

### 4.1.1 Dataset

The dataset for evaluation is a synthetic dataset provided by the PETs competition organizer. The dataset contains approximately three million synthetic transaction records and account data from a payment network system and a group of banks. The percentage of anomaly transactions is 1%. As described in Section 2.3 and 2.4, the transaction data is hosted at a payment network system client, which contains features such as the transaction amount, transaction frequency, and the amount for the currency used in each transaction. The account data, which contains account meta information are horizontally partitioned and hosted by multiple bank clients. The provided account data has one important account-level feature, Flag, which is finite and indicates the status of the account.

### 4.1.2 Evaluation Metric

The metric used for evaluating the effectiveness of the models is Area under the Precision-Recall Curve (AUPRC), also known as Average Precision (AP). This is a commonly used metric for anomaly detection problems, as it focuses more on the anomalies than the negative class (normal instances). AUPRC is computed as follows:

$$AUPRC = {\sum }_{n} ( {R}_{n} - {R}_{n - 1} ) {P}_{n}$$

where Pₙ and Rₙ are the precision and recall, respectively, when thresholding at the n-th individual transaction sorted in order of increasing recall.

### 4.1.3 Methods for Evaluation

The following solutions were evaluate on the provided dataset: PNS Only: the solution only uses PNS data, specifically PNS client purely employs the Xgboost model on transaction-level data without using Bank's accounts information such as Flag. Centralized (PNS+Bank): The proposed centralized solution, as detailed in Section 3.2. Federated (PNS+Bank): The proposed federated solution, as detailed in Section 3.3. The evaluation of centralized and federated solutions considers variations in two critical parameters—the acceptable false negative ratio κ of the bloom filter, where a lower value gives more accuracy for the bloom filter but requires increased capacity (memory) and computational costs, and the privacy budget, i.e., the value of ε>0, for differential privacy applied on dataset features (smaller values of e provide stronger privacy protection but at the expense of utility such as the effectiveness of the model).

The solution was compared with the other solutions in the PETs Competition's leaderboard. The evaluation of PETs competition is under one centralized scenario and three federated scenarios with different numbers of bank clients and data splitting.

### 4.1.4 Implementation Details

The experiments are implemented in Python, leveraging the Flower framework for federated learning execution, the Xgboost library for model development, and pycryptodome library for all cryptographic operations. Within these experiments, the federated learning environment, including the simulation of multiple clients and communication between clients, was emulated using Flower's built-in simulation module with a multi-processing approach so that experiments could be conducted on a single machine. The machine for running experiments contains a 16-core Intel Core i7 CPU and 32 GB of memory. Security parameters for the system's encryption and decryption, such as the RSA Public key, AES session key, and XOR key, are set to a length of 32.

### 4.2 Results

### 4.2.1 Effectiveness of Proposed Methods

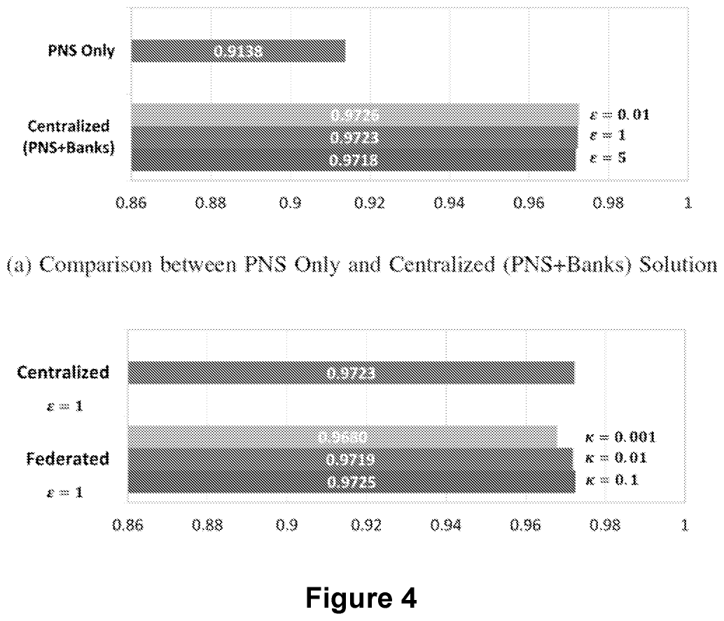

FIG. 4 shows the final average precision (AP) scores of the anomalous transaction detection task on the dataset and setup where there are four bank clients. FIG. 4a compares the PNS Only solution with Centralized solutions with different differential privacy budgets. As demonstrated in FIG. 4a, by integrating PNS transaction-level data with Bank account-level data, there is an approximate 6 percent increase in the average precision (AP) score (from 0.91 to 0.97). The impact of different DP budgets on the Centralized solution is not drastic, which may be attributed to the weak correlation of the sensitive attributes overall as well as more pronounced differences between the marginal distribution of anomalies compared to normals.

FIG. 4b compares the Centralized and Federated solutions under a DP budget of 1, across varying bloom filter false negative rates for the federated solution. As demonstrated in FIG. 4b, the proposed federated Solution can achieve a similar average precision (AP) score as the centralized approach under different bloom filter false negative rates, thereby validating the effectiveness of the federated solution.

The overall evaluation results demonstrate that the proposed method can provide excellent detection ability for anomalous transactions in both centralized and federated settings.

TABLE 1
Efficiency of Proposed Federated Solution
under four banks scenario.

| | Efficiency | | | | |
|---|---|---|---|---|---|
| | PNS | Bank1 | Bank2 | Bank3 | Bank4 |
| Time (Minutes) | 17 | 0.58 | 0.60 | 0.68 | 0.67 |
| Peak Memory (GB) | 7.13 | 0.34 | 0.34 | 0.67 | 0.38 |
| Network (GB) | 1.44 | 0.32 | 0.31 | 0.72 | 0.71 |

### 4.2.2 Efficiency and Scalability

The efficiency and scalability of the methods were highlighted. For this, the overall runtime of clients and server in minutes (Time) were measured, the peak memory usage across all the clients during the training phase in gigabytes (Peak Memory), and the total size of resources used in communication between clients and server in gigabytes (Network).

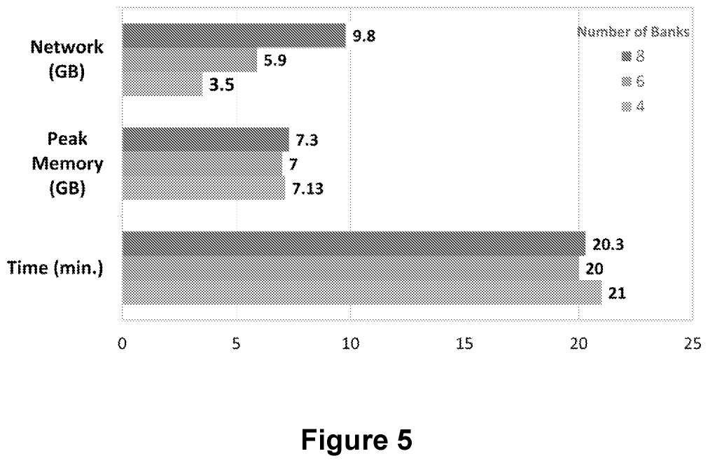

Table 1 presents runtime, peak memory usage, and network usage for each party under the scenario where there are four bank clients. The proposed method demonstrates efficiency for both PNS and bank clients, capable of completing tasks within 20 minutes while consuming less than 10 GB of memory. FIG. 5 shows the total runtime, peak memory usage, and network usage under scenarios with different numbers of bank clients. The results from FIG. 5 revealed that the method maintains efficiency as the number of clients increases. This is primarily due to the fact that model fitting, which constitutes the most computationally intensive bottleneck, occurs exclusively on PNS's end. Hence, the approach proves to be highly scalable, adeptly handling the expansion in the number of partitions without significant efficiency degradation

TABLE 2
Evaluation from Leaderboard

| | Centralized | | Federated | |
|---|---|---|---|---|
| Method | AP | AP@N1 | AP@N2 | AP@N3 |
| ILLIDAN Lab | 0.4457 | 0.6784 | 0.6466 | 0.6466 |
| PPMLHuskies | 0.9801 | 0.9494 | 0.9610 | 0.9477 |
| Visa | 0.7949 | 0.5219 | 0.5121 | 0.4575 |
| The present approach | 0.9741 | 0.9751 | 0.9748 | 0.8941* |

4.2.3 Comparison with Other Solutions in PETs Challenge

As summarized in Table 2, the method was compared against the other solutions from the PETs competition. The approach can achieve the high average precision (AP) score in the centralized setting, with results of 0.97 AP score close to the PPMLHuskies by a marginal difference of 0.006. Across three distinct federated learning scenarios, the method attained an average precision (AP) score of 0.97, slightly higher than PPMLHuskies and significantly surpassing other leading solutions, such as those from Visa and ILLIDAN. Notably, during the third phase of the PETs competition, which involved adversarial attack testing of various methods, the approach emerged as the winner in the final assessment. However, due to the organizers' decision not to disclose the adversarial test details, those specific results cannot be displayed here. The PETS Challenge results further support the effectiveness and robustness of the solution.

### 5 DISCUSSIONS AND CONCLUSION

This example introduces a novel privacy-preserving method for payment network systems (PNS) and banks to collaborate and leverage their data to enhance the detection of fraudulent wires using anomaly detection. The method works in two steps. In the first step, bank clients collaboratively mine account-level features/rules and securely share this information with the PNS, utilizing secure Bloom Filters and secure aggregation. In the subsequent step, the PNS generates additional features by querying the secure aggregated Bloom Filter and trains a classifier on the augmented datasets. Further, to guard against model inversion and membership inference attacks, the PNS protects sensitive features using a differentially private mechanism. For the PETs challenge, the implementation focused on flag-based rule mining, leveraging the unique “flag” data field held by banks. This approach perfectly suits the challenge when flag information significantly contributes to classification performance, yet it can also be extended to other account-level data. For example, banks can formulate more sophisticated flag-based rules using anomaly ratios, creating additional Bloom Filters and features. Additionally, banks can train local classifiers to determine transaction-associated account risk scores, and encode this information via secure Bloom Filters. The PNS can then use this score data for final predictions, either by generating additional features or through an ensemble approach.

The solution demonstrates state-of-the-art performance on the PETs challenge datasets, excelling in both accuracy and scalability by leveraging informative rule mining and shifting the computational load to the PNS (or server) side. Furthermore, the drop is performance going from centralized solution to its federated counterpart is negligible, which stands in contrast with other approaches. However, it encounters two limitations. Firstly, the data-dependent nature of rule mining, while effective for account flag data, complicates the extraction of informative rules from other features. To address this, future work will explore data-driven approaches, such as neural networks, to extract valuable representations. Secondly, the efficiency gained from using Bloom Filters is contingent on the availability of informative rules. A significant number of rules may lead to increased communication overhead during the secure aggregation. To tackle this issue, Alternatives like the counting Bloom Filter were considered, which may offer a more scalable solution.

The following provides additional implementation details specific to the PETs challenge.

### PETS Challenge Implementation

### Rule Mining

After an extensive analysis and evaluation, the provided data is such that for any transaction (τ∈T) whenever ordering or receiving account is flagged (i.e., oFlag(τ)≠0) or bFlag(τ)≠0)), the transaction is an intrinsic anomaly, and the complex anomalies are limited to the non-flagged accounts (i.e., for oFlag(τ)=bFlag(τ)=0).

Thus, for the competition, there is no need for feature mining; hence, a single feature was used, which corresponds to the rule (stated above) that a transaction is an intrinsic anomaly if the ordering or the beneficiary account is flagged, otherwise it may be a complex anomaly. This approach has saved us the privacy budget (in terms of overall DP-guarantee), information leakage associated with rule mining (e.g., which rules, in terms of Flag values, have sufficient support and are relevant), and computational resources.

In the technical approach, how the implementation and strategy was adjusted for the given data and the setting is described. For more general data distributions and settings, a couple of adjustments need to be made. Firstly, take the features (akin to account-level features) and discretize them, making sure that the discretized features are in the finite space. Next, combine these discretized features into a single feature, which now will become equivalent to Flag feature. Now by incorporating feature mining over the newly created Flag feature, the problem can be solved in a more general setting.

### Bloom Filter Implementation Details

The provided data is such that a transaction is anomalous whenever ordering or receiving account is flagged (as discussed at the end of the previous section); additionally, the same is true when the provided account information for a transaction is incorrect. The first two encoding approaches (described above) can be combined to give a simple and elegant encoding via one bloom filter.

Here's how it works. Take ‘acc_info’(=acc #name∥street country) for all the accounts that are not flagged (i.e., their corresponding Flag value is 0) and add them to the single bloom filter. Now, when a given ‘acc_info’ (which maybe incorrect) was checked, whether it is in the filter was checked; if it is, the information is valid and the account is not flagged, otherwise either the account information is incorrect or the account is flagged. Importantly, when the account information is not found in the bloom filter, one cannot distinguish whether the account information was incorrect or if the account is flagged; thus, it inherently provides privacy-protection (i.e., plausible deniability) for the Flag values and the validity of the account information.

For the federated BFs, the standard AES block cipher was used as a PRF, and SHA3 was used as the cryptographic hash function. The secure sum and collaborative secure key generation procedures were used in Flower. As discussed in centralized setting (3.2) and previous section, one bloom filter for rules was used for encoding. Although in general a public key infrastructure was relied on, for example, the one already existing in PNS, here RSA public-private key pairs were generated and used to communicate information that has to be kept secret from other parties, for example when generating the key or when banks share their local bloom filters with PNS. Other implementation details are the same as described in the centralized setting in Section 3.2.

### Dataset Processing

For the provided data, the following features were identified as strong predictors: ‘settlement_amount’, ‘instructed_amount’, ‘sender_currency_avg_amount’, ‘receiver_currency_avg_amount’, ‘sender_hour_freq’, ‘receiver_hour_freq’, ‘sender_currency_freq’, ‘-receiver_currency_freq’, ‘sender_receiver_freq’, ‘receiver_in_degree’, ‘BF’, ‘hour’, ‘day’, ‘datediff’.

‘sender’ and ‘receiver’ are the banks respectively sending and receiving a transaction, ‘freq’ in the feature name stands for frequency; thus sender hour freq gives the hourly frequency of a bank as sender and sender receiver freq gives how often (relative to other banks) a given bank (sender) sends a transaction to the bank given as receiver. ‘sender/receiver_currency_freq’: the frequency of each currency's usage in all transactions made by or to a specific sender or receiver bank, ‘sender/receiver_currency_avg_amount’: the average transaction amount for each currency used in all transactions by each sender or receiver bank. ‘sender_receiver_freq’ the number of transactions between each pair of sender and receiver bank across all transactions in the dataset. ‘receiver_in_degree’ for each receiver bank, the number of unique sender banks that have transaction records with it. ‘BF’ is the bloom filter encoding based augmented feature. The ‘datadiff’ is a binary feature, which has value 1 if the transaction and settlement date are apart by at least one day, and 0 otherwise.

The aim was to find non-sensitive or the less sensitive features, which were also strong predictors. Thus, account information or Flag (directly) was not employed, and instead this information was encoded in a privacy-preserving way using the BF feature (list of sensitive information is given in Section 3.1). Since timestamp is sensitive information, generalization was used, and differential privacy to protect information regarding it. Hour and day level generalization of time was used instead of an exact time. Differential privacy for computing hourly frequencies was assured by using DP Laplace mechanism.

Federated Solution within the Flower Framework

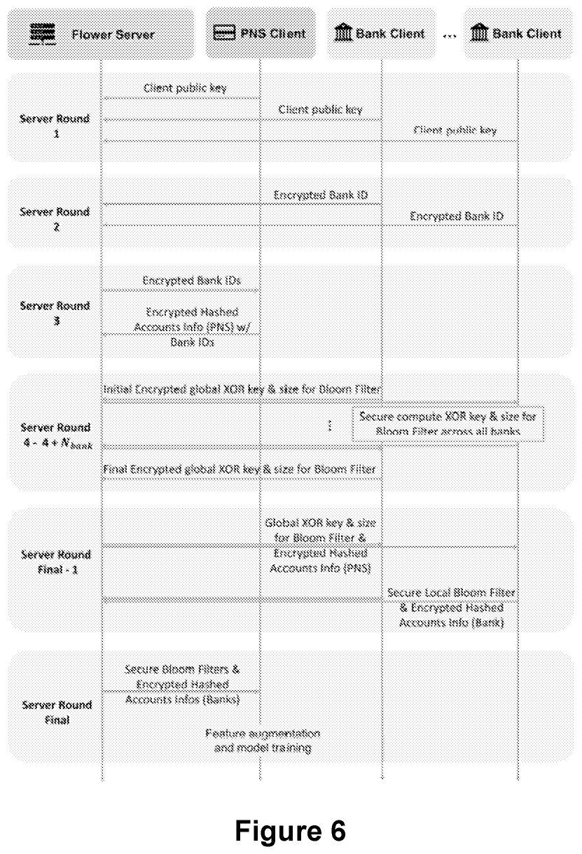

As requested in the challenge, the implementation of the proposed federated solution is based on the Flower framework. In the design of the common federated learning framework such as Flower, there is no peer-to-peer communication functionality between clients. To exchange information with each other, clients need to rely on the central server as the intermediary. The detailed communication flow between server, PNS, and Bank clients of the proposed federated solution during the training stage implemented under the flower framework is depicted in FIG. 6. In summary, in Round 1, the server collects all public keys from all Bank and PNS clients for subsequent secure information exchanges. In Rounds 2-3, each Bank client sends its Bank ID to the server and then forwards it to the PNS client. The PNS client computes hashes of the account information from its transactions data, aligns them with the corresponding bank using the received Bank IDs, and sends this information back to the server. Starting from round 4, the clients engage in multiple rounds of communication with the server, corresponding to the number of clients to collaboratively and securely compute the common XOR encryption key and the size of the Bloom Filter. Then, in the following round, each Bank client utilizes these parameters to construct its local Bloom filter based on its local account meta information (account details and Flag) and transmits it to the server. In the final round, these local bloom filters are dispatched to the PNS client. The PNS client builds a global bloom filter from these local bloom filters to conduct feature augmentation and model training.

### Additional Definitions

To aid in understanding the detailed description of the compositions and methods according to the disclosure, a few express definitions are provided to facilitate an unambiguous disclosure of the various aspects of the disclosure. Unless otherwise defined, all technical and scientific terms used herein have the same meaning as commonly understood by one of ordinary skill in the art to which this disclosure belongs.

The terms “memory,” “memory device,” “computer-readable storage medium,” “data store,” “data storage facility,” and the like each refer to a non-transitory device on which computer-readable data, programming instructions or both are stored. Except where specifically stated otherwise, the terms “memory,” “memory device,” “computer-readable storage medium,” “data store,” “data storage facility,” and the like are intended to include single device embodiments, embodiments in which multiple memory devices together or collectively store a set of data or instructions, as well as individual sectors within such devices.

The terms “processor” and “processing device” refer to a hardware component of an electronic device that is configured to execute programming instructions. Except where specifically stated otherwise, the singular term “processor” or “processing device” is intended to include both single-processing device embodiments and embodiments in which multiple processing devices together or collectively perform a process.

The terms “instructions” and “programs” may be used interchangeably herein. The instructions may be stored in object code format for direct processing by the processor, or in any other computing device language, including scripts or collections of independent sThece code modules that are interpreted on demand or compiled in advance. Functions, methods, and routines of the instructions are explained in more detail below. The instructions may be any set of instructions to be executed directly (such as machine code) or indirectly (such as scripts) by the processor. For example, the instructions may be stored as computing device code on the computing device-readable medium.

In addition, the terms “unit,” “-er,” “-or,” and “module” described in the specification mean units for processing at least one function and operation, and can be implemented by hardware components or software components and combinations thereof.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (|SA) instructions, machine instructions, machine-dependent instructions, microcode, firmware instructions, state-setting data, or either sThece code or object code written in any combination of one or more programming languages, including an object-oriented programming language such as Smalltalk, C⁺+ or the like, and conventional procedural programming languages, such as the “C” programming language or similar programming languages. The computer-readable program instructions may execute entirely on the user's computer, partly on the user's computer, as a stand-alone software package, partly on the user's computer, and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry, including, for example, programmable logic circuitry, field-programmable gate arrays (FPGA), or programmable logic arrays (PLA), may execute the computer-readable program instructions by utilizing state information of the computer-readable program instructions to personalize the electronic circuitry, in order to perform aspects of the present invention.

These computer-readable program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

Aspects of the present disclosure are described herein with reference to flowchart illustrations and/or block diagrams of methods, apparatus (systems), and computer program products according to embodiments of the invention. In some embodiments, the flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Unless specifically stated otherwise, it is appreciated that throughout the disclosure, descriptions utilizing terms such as “obtaining,” “performing,” “receiving,” “computing,” “associating,” “assigning,” “traversing,” “calculating,” “determining,” “identifying,” “transforming,” “ranking,” “providing,” “transmitting,” or the like, refer to the action and processes of a computer system, or similar electronic computing device, that manipulates and transforms data represented as physical (or electronic) quantities within the computer system memories or registers or other such information storage, transmission or display devices.

As used herein, the term “logistic regression” is a regression model for binary data from statistics where the logit of the probability that the dependent variable is equal to one is modeled as a linear function of the dependent variables.

As used herein, the term “neural network” is a machine learning model for classification or regression consisting of multiple layers of linear transformations followed by element-wise nonlinearities typically trained via stochastic gradient descent and back-propagation.

The term “machine learning,” as used herein, refers to a computer algorithm used to extract useful information from a database by building probabilistic models in an automated way.

The term “regression tree,” as used herein, refers to a decision tree that predicts values of continuous variables.

It will be understood that, although the terms “first,” “second,” etc., may be used herein to describe various elements, components, regions, layers and/or sections. These elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

It is noted here that, as used in this specification and the appended claims, the singular forms “a,” “an,” and “the” include plural reference unless the context clearly dictates otherwise. The terms “including,” “comprising,” “containing,” or “having” and variations thereof are meant to encompass the items listed thereafter and equivalents thereof as well as additional subject matter unless otherwise noted.

The phrases “in one embodiment,” “in various embodiments,” “in some embodiments,” and the like are used repeatedly. Such phrases do not necessarily refer to the same embodiment, but they may unless the context dictates otherwise.

The terms “and/or” or “/” means any one of the items, any combination of the items, or all of the items with which this term is associated.

As used herein, the term “each,” when used in reference to a collection of items, is intended to identify an individual item in the collection but does not necessarily refer to every item in the collection. Exceptions can occur if explicit disclosure or context clearly dictates otherwise.

The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

All methods described herein are performed in any suitable order unless otherwise indicated herein or otherwise clearly contradicted by context. In regard to any of the methods provided, the steps of the method may occur simultaneously or sequentially. When the steps of the method occur sequentially, the steps may occur in any order, unless noted otherwise.

In cases in which a method comprises a combination of steps, each and every combination or sub-combination of the steps is encompassed within the scope of the disclosure unless otherwise noted herein.

Each publication, patent application, patent, and other reference cited herein is incorporated by reference in its entirety to the extent that it is not inconsistent with the present disclosure. Publications disclosed herein are provided solely for their disclosure prior to the filing date of the present invention. Nothing herein is to be construed as an admission that the present invention is not entitled to antedate such publication by virtue of prior invention. Further, the dates of publication provided may be different from the actual publication dates which may need to be independently confirmed.

It is understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A method for anomaly identification through privacy-enhanced two-step federated learning, comprising:
determining a simple rule for each of a plurality of parties based on transactional data possessed by each party;
encoding the simple rule for each party using a local bloom filter that is specific for each party;
merging all local bloom filters of the plurality of parties by an aggregator through federated learning to generate a global bloom filter;
removing intrinsic anomalies from the transactional data by the aggregator using the global bloom filter to obtain an augmented dataset of the transactional data;
determining a classifier by the aggregator based on the augmented dataset; and
identifying complex anomalies using the classifier.

2. The method of claim 1, wherein the step of merging is performed by garbled circuits.

3. The method of claim 1, wherein the step of determining the classifier is performed by training the classifier with XGBoost.

4. The method of claim 1, wherein the step of determining the classifier comprises augmenting the transactional data with account-level features.

5. The method of claim 1, wherein the parties comprise banks and the aggregator comprises a financial institute.

6. The method of claim 5, wherein the transactional data comprises bank transactional data.

7. The method of claim 1, wherein the transactional data comprises account information.

8. The method of claim 1, wherein the simple rule comprises a rule-based classifier.

9. The method of claim 1, wherein the step of determining the simple rule comprises encrypting the transactional data.

10. The method of claim 1, wherein the intrinsic anomalies have an anomaly ratio greater than or equal to a threshold value.

11. The method of claim 10, wherein the threshold value is 0.95.

12. The method of claim 1, wherein the complex anomalies comprise statistical anomalies.

13. The method of claim 1, wherein the aggregator is implemented on one or more server devices.

14. The method of claim 1, wherein the classifier comprises a model based on linear regression, logistic regression, decision trees, support vector machines (SVM), naive Bayes, k-nearest neighbors or K-nearest neighbors (k-NN), K-means clustering, random forest, dimensionality reduction algorithms, gradient boosting algorithms, or neural networks.

15. The method of claim 1, wherein the classifier comprises one or more machine learning models.

16. The method of claim 1, wherein the classifier comprises a neural network, a convolutional neural network (CNN), a deep convolutional neural network (DCNN), a cascaded deep convolutional neural network, a simplified CNN, a shallow CNN, or a combination thereof.

17. The method of claim 1, wherein the classifier is trained by:
determining a simple rule for each of a plurality of parties based on transactional data possessed by each party;
encoding the simple rule for each party using a local bloom filter that is specific for each party;
merging all local bloom filters of the plurality of parties by an aggregator through federated learning to generate a global bloom filter;
removing intrinsic anomalies from the transactional data by the aggregator using the global bloom filter to obtain an augmented dataset of the transactional data; and
training a classifier by the aggregator based on the augmented dataset.

18. The method of claim 17, wherein the step of merging is performed by garbled circuits.

19. The method of claim 17, wherein the step of determining the classifier is performed by training the classifier with XGBoost.

20. The method of claim 17, wherein the step of determining the classifier comprises augmenting the transactional data with account-level features.
